(19) United States
(12) Patent Application Publication
(10) Pub. No.: US 2006/0031352 A1
(43) Pub. Date: Feb. 9, 2006

(54) Tamper-proof electronic messaging

(76) Inventors: Justin Marston, Richmond (GB); Andrew Stuart Hatch, Hurworth-on-Tees (GB)

Correspondence Address: FENWICK & WEST LLP, SILICON VALLEY CENTER, 801 CALIFORNIA STREET, MOUNTAIN VIEW, CA, 94041, US

(21) Appl. No.: 11/129,231

(22) Filed: May 12, 2005

Related U.S. Application Data
(60) Provisional application No. 60/570,848, filed on May 12, 2004.
(60) Provisional application No. 60/570,861, filed on May 12, 2004.
(60) Provisional application No. 60/612,436, filed on Sep. 22, 2004.

(51) Int. Cl. G06F 15/16

(52) U.S. Cl. 709/206; 709/203

(57) ABSTRACT

A messaging system treats a set of related messages, such as an email string between two or more people, as a message container (200) having relational references to one or more submessages (210, 212, 214). A messaging server (112) stores the messages and submessages as discrete message components within a message database (416). The messaging server (112) generates (714) tamper-detection data, such as hashes, for the message components and stores the data in an audit information database (418). The messaging server (112) authenticates (627) a message component by generating new tamper-detection data for the component, and comparing the new data with the stored data. In addition, the messaging server (112) can distribute the tamper-detection information to other entities, such as messaging clients (116), by signing the data using a digital signature. The messaging system thus allows distributed entities to verify the authenticity of messages and components sent via the system.

### CROSS-REFERENCE TO RELATED APPLICATIONS

This application claims the benefit of U.S. Provisional Application No. 60/570,848, filed May 12, 2004, No. 60/570,861, filed May 12, 2004, and No. 60/612,436, filed Sep. 22, 2004, all of which are hereby incorporated by reference herein. This application is related to U.S. Utility application Ser. No. 10/789,461, filed Feb. 26, 2004, Ser. No. 10/977,354, filed Oct. 28, 2004, and <ATTORNEY DOCKET NO. 10344>, filed May 12, 2005, all of which are hereby incorporated by reference herein.

### BACKGROUND OF THE INVENTION

1. Field of the Invention

This invention pertains in general to electronic messaging and in particular to authenticating electronic messages delivered via a network such as the Internet.

2. Description of the Related Art

Before the introduction of e-mail, business users relied on two forms of communication—the phone and the business letter. The former was momentary and casual, the latter was retained as a business record and was considered formal. E-mail has blurred those two communication requirements into one tool—people use it both formally and casually, but it is retained for an indefinite time period (typically years) depending on how an enterprise's Information Technology (IT) system has been set up.

Enterprises are now searching for a way to deal with the problem of separating communications that constitute business records from the general ‘chatter’ of e-mail. Such business records must be retained in a manner that reflects the business processes to which the content relates.

A further problem with current e-mail systems is that messages are just simple text strings. When a user writes a message, it is formed into the first e-mail, but may then go on to be included in many other e-mails during its lifetime. This results in many copies of the same, user-authored, message in different, unrelated, mail “snapshots.” This is an inefficient way to store messages and makes enforcing a retention policy, access rights, security or any other property onto the messages nearly impossible, as the content cannot be tracked through all of its separate instances in the mail system. Moreover, it is difficult to verify the authenticity of a message, and to verify that the message has not been altered. These are very significant problems for companies attempting to achieve compliance with internal or government-mandated regulations. Likewise, the same problems make it difficult to authenticate emails as business records in criminal and civil legal proceedings.

Therefore, there is a need in the art for an electronic messaging system that allows the messages to be authenticated.

### BRIEF SUMMARY OF THE INVENTION

The above need is met by a messaging system that treats a set of related messages, such as an email string between two or more people, as a message container (200) having relational references to one or more submessages (210, 212, 214). A messaging server (112) stores the messages and submessages as discrete message components within a message database (416). The messaging server (112) generates (714) tamper-detection data, such as hashes, for the message components and stores the data in an audit information database (418). The messaging server (112) authenticates (627) a message component by generating new tamper-detection data for the component, and comparing the new data with the stored data. In addition, the messaging server (112) can distribute the tamper-detection information to other entities, such as messaging clients (116), by signing the data using a digital signature. The messaging system thus allows distributed entities to verify the authenticity of messages and components sent via the system.

### BRIEF DESCRIPTION OF THE DRAWINGS

FIG. 1 is a high-level block diagram illustrating an environment including an embodiment of a messaging system.

FIG. 2 is a block diagram illustrating a representation of a message exchanged according to an embodiment of the messaging system.

FIG. 3 illustrates a set of interactions that explain the relationship among messages, current submessages, and history submessages.

FIG. 4 is a high-level block diagram illustrating modules within the messaging server according to one embodiment of the messaging system.

FIG. 5 is a high-level block diagram illustrating modules within the messaging client according to one embodiment of the messaging system.

FIG. 6 is a flow diagram illustrating transactions between a messaging client, a proxy server, and a messaging server according to one embodiment.

FIG. 7 is a flow diagram illustrating transactions between a messaging client, a proxy server, and a messaging server according to one embodiment.

The figures depict an embodiment of the present invention for purposes of illustration only. One skilled in the art will readily recognize from the following description that alternative embodiments of the structures and methods illustrated herein may be employed without departing from the principles of the invention described herein.

### DETAILED DESCRIPTION OF THE PREFERRED EMBODIMENTS

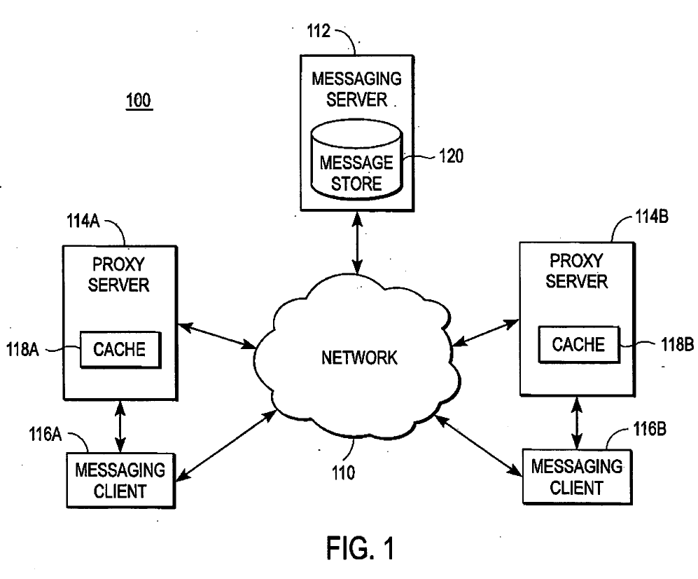

FIG. 1 is a high-level block diagram illustrating an environment 100 including an embodiment of a messaging system. The environment 100 of FIG. 1 includes a network 110, messaging server 112, multiple proxy servers 114, and multiple messaging clients 116. End-users of messaging clients 116 use the messaging system to send messages to other end-users. The messages are stored by the messaging server 112, and components of the messages are optionally stored in caches 118 at the proxy servers.

In the embodiment of FIG. 1, the messaging system shares characteristics with the system described in U.S. patent application Ser. No. 10/789,461, which is incorporated by reference herein. As described in that application, the messaging system uses a relational model to represent and store messages exchanged among the end-users.

FIG. 1 and the other figures use like reference numerals to identify like elements. A letter after a reference numeral, such as “114A,” indicates that the text refers specifically to the element having that particular reference numeral. A reference numeral in the text without a following letter, such as “114,” refers to any or all of the elements in the figures bearing that reference numeral (e.g. “114” in the text refers to reference numerals “114A” or “114B” in the figures).

As used herein, the term “message” refers to a data communication sent by one end-user to one or more end-users of the messaging system or another messaging system. In one embodiment, described below, a message is a container having relational references to content and/or audit data. In another embodiment, the messages are emails, Short Message Service (SMS) messages, Instant Messages (IMs), Multi-Media Message (MMS) and/or other types of messages. The term “message” can also include media files, such as discrete and/or streaming audio and/or video, still images, etc. An end-user can perform various actions on messages, including composing, sending, reading, replying to, and forwarding.

The network 110 enables data communication between and among the entities connected to the network and allows the entities to exchange messages. In one embodiment, the network 110 is the Internet. The network 110 can also utilize dedicated or private communications links that are not necessarily part of the Internet. In one embodiment, the network 110 uses standard communications technologies and/or protocols. Thus, the network 110 can include links using technologies such as Ethernet, 802.11, integrated services digital network (ISDN), digital subscriber line (DSL), asynchronous transfer mode (ATM), etc. Similarly, the networking protocols used on the network 110 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), as were the various messaging protocols described below. The data exchanged over the network 110 can be represented using technologies and/or formats including the hypertext markup language (HTML), the extensible markup language (XML), etc. In addition, all or some of links can be encrypted using conventional encryption technologies such as the secure sockets layer (SSL), Secure HTTP and/or virtual private networks (VPNs). In another embodiment, the entities can use custom and/or dedicated data communications technologies instead of, or in addition to, the ones described above.

In one embodiment, the messaging server 112 acts as a central repository for messages received by the end-users of the messaging system. The messaging server 112 can communicate with the messaging clients 116 and proxy servers 114 via the network 110. In some embodiments, the messaging server 112 can also communicate with messaging servers and clients of other messaging systems via the network 110. The messaging server 112 provides interfaces that allow other entities in the messaging system, such as the proxy servers 114 and/or messaging clients 116 to exchange messages with it.

The messaging server 112 includes a message store database 120 that stores information about each message exchanged using the messaging system, or at least a designated subset of the messages exchanged using the system. In one embodiment, the stored information includes the content of the message and any audit, security, and/or governance policy information that are applicable to the message. As used herein, the term “database” refers to an information store and does not imply that the data within the database are organized in a particular structure beyond that described herein. Although only a single database 120 is illustrated in FIG. 1, embodiments of the messaging server 112 can utilize multiple databases. In addition, the database 120 can be local or remote to the messaging server 112. For example, in one embodiment the audit information is maintained in a separate database controlled by an audit server. In FIG. 1, the database 120 is illustrated as being local to the messaging server 112 for purposes of clarity.

A proxy server 114 communicates with the messaging server 112 via the network 110. In addition, the proxy server 114 communicates with one or more messaging clients 116 via the network 110. Although FIG. 1 shows a direct connection between the proxy server 114 and the messaging clients 116, those of skill in the art will recognize that this connection can be made over the network 110.

In one embodiment, the proxy server 114 acts as a messaging server with respect to the messaging clients 116 and acts as a messaging client with respect to the messaging server 112. Accordingly, the proxy server 114 can exchange messages with the messaging clients 116 and with the messaging server 112. In one embodiment, the proxy server 114 includes a message cache 118 for storing messages and related information passing through the proxy server 114. In general, the message cache 118 stores local copies of messages held in the message store database 118. When the proxy server 114 receives a request for a message from a messaging client 116, the proxy server 114 seeks to fulfill the request using a copy of the message stored in the message cache 118. This arrangement decreases the latency of providing the message to the messaging client 116, and reduces both the processing and bandwidth requirements for the messaging server 112. One embodiment of the messaging system lacks the proxy server 114. In such an embodiment, the messaging clients 116 directly communicate with the messaging server 112 via the network 110.

The messaging client 116 is a device utilized by an end-user to compose, view, and perform other tasks with the messages. The messaging client 116 is connected to the network 110 and can communicate with the proxy server 114, messaging server 112, and/or other entities coupled to the network. In one embodiment, the messaging client 116 is a computer system executing standard messaging software, such as MICROSOFT OUTLOOK or LOTUS NOTES. In other embodiments, the messaging client 116 executes specialized messaging software. Depending upon the embodiment, some or all of the clients 116 can be other types of electronic devices, such as personal digital assistants (PDAs), cellular telephones with text messaging functionality, portable email devices, etc.

In one embodiment, the messaging server 112 maintains audit information for each message component utilized in the system. The audit information includes tamper-detection data that can be used by the messaging server 112, the messaging clients 116, and/or other entities to determine whether any components of a message have been altered. It is therefore possible to authenticate entire strings of related message components, even if the components were created by different messaging clients and passed through multiple messaging servers 112. This capability can be used in many situations where message authentication is required, such as to guarantee compliance with policies or regulations, and/or in legal proceedings.

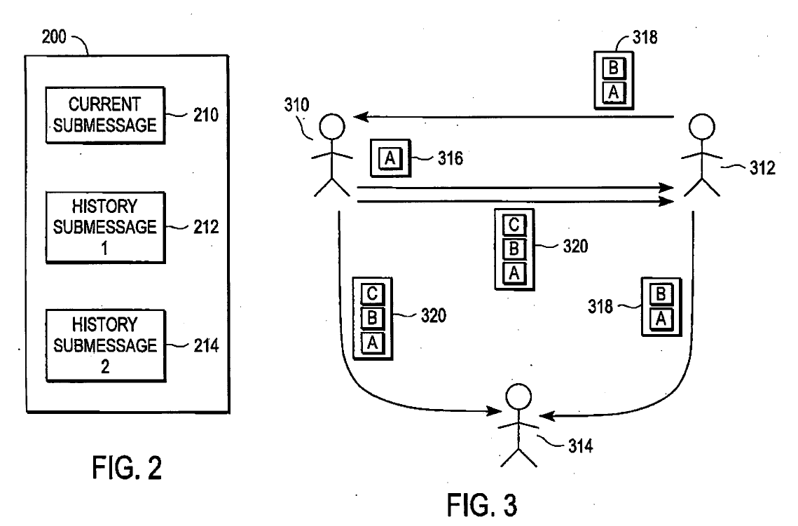

FIG. 2 is a block diagram illustrating a representation of a message 200 exchanged according to an embodiment of the messaging system. A message can be thought of as a container with relational references. The container itself does not contain content, but rather points to submessages and/or attachments in which content resides. In addition, the container can point to other information about the message, such as audit, security, and governance policy information. A message can also be conceptualized as a document having multiple paragraphs, where each paragraph can be individually identified and isolated. Multiple people can contribute paragraphs to the document, and the document itself can be formed of references to paragraphs written by the different authors. In one embodiment, the message container is extensible, and can point to other types of data such as patient codes, embedded graphics, and questionnaires. This description uses the term “message components” to refer to the message, submessages, attachments, audit information, etc.

When an end-user composes and sends a message, she is actually composing a submessage, and then sending a message 200 containing a reference to the submessage 200 to other end-users. The submessage composed and sent by the end-user is called the “current submessage.” Any submessages that were previously in the message are called “history submessages.” For example, if an end-user receives a message containing one submessage, at the time of receipt the single submessage is the current submessage. When the end-user composes and sends a reply, the submessage containing the reply becomes the current submessage, and the other submessage becomes a history submessage.

The end-user can also associate one or more attachments with a submessage. In one embodiment, the attachments are relationally-referenced within a message in the same manner as submessages. Thus, attachments can be treated in the same manner as submessages and descriptions of submessages contained herein are equally applicable to attachments. The exemplary message 200 of FIG. 2 contains one current submessage 210 and two history submessages 212, 214 representing previously sent submessages within the message 200.

FIG. 3 illustrates a set of interactions that explain the relationship among messages 200, current submessages 210, and history submessages 212, 214. The figure illustrates three people, Alice 310, John 312, and Peter 314. Initially, Alice 310 composes a message 316 containing submessage A and sends it to John 312. John 312 replies 318 and also copies the message to Peter 314. In the reply 318, submessage B is the current submessage and submessage A becomes a history submessage. Next, Alice 310 replies to both John 312 and Peter 314 and sends a third version 320 of the message having a new current submessage C, and two history submessages A and B.

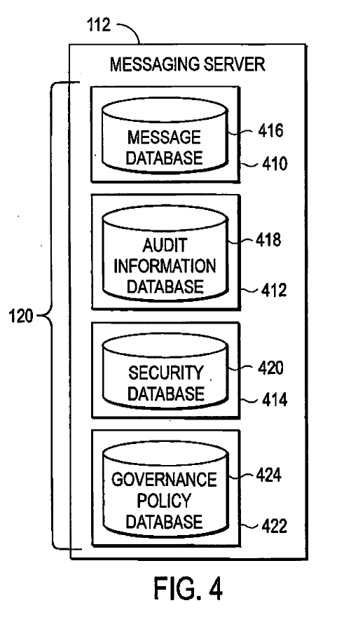

FIG. 4 is a high-level block diagram illustrating modules within the messaging server 112 according to one embodiment of the messaging system. In the illustrated embodiment, the messaging server 112 includes a messaging module 410, an auditing module 412, a security module 414, and a governance module 422. These modules respectively contain a message database 416, an audit information database 418, a security database 420, and a governance policy database 424. Although separate modules and databases are illustrated in FIG. 4, in some embodiments these elements are combined and/or distributed in different manners than shown.

The message module 410 controls the message database 416. This database 416 stores messages, submessages, attachments, and other related data. These data are stored as logically discrete components, meaning that each message component can be accessed separately. In one embodiment, the message database 416 associates a unique ID with each message component. These IDs are utilized throughout the messaging system to refer to the components. In one embodiment, the IDs are relatively long in order to reduce the chance that a malicious actor can forge a valid ID.

The auditing module 412 generates audit information and interacts with the audit information database 418. The audit information describes the usage of the messaging system. Audit information thus indicates which end-users composed which submessages, which users read which submessages, which users replied to and/or forwarded which submessages, etc. The audit information can also describe characteristics of the message components such as sensitivity levels for particular submessages.

In one embodiment, the audit information includes tamper-detection data utilized to ensure the authenticity of message components and/or other information stored by the messaging server 112. In one embodiment, the auditing module 412 generates the tamper-detection data by applying a hash function, such as SHA-1 or MD5, to the content that will be authenticated. The hash function is a one way function that generates a value (e.g., an integer) called a “hash” based on input data. The input data can be authenticated by generating a new hash and comparing it to the first hash. If the hashes match, the input data has not been tampered with and thus the data are authenticated.

In one embodiment, the tamper-detection data are generated by the audit information module 412 based on the message data in the message database 416 and/or the audit information in the audit information database 418. For example, in one embodiment, the hash used as tamper-detection information for a submessage is based on one or more of the following pieces of information:
Date—When the submessage was sent.
Author—The person who authored or sent the submessage.
Recipients—The (first) set of recipients for the submessage.
Content—The actual submessage itself.
   Each hash is associated with the message component to which it pertains.

The audit information database 418 stores audit information for the messaging system. In one embodiment, the audit information database 418 stores at least some of the audit information on write-once, read-many media, such as a writable CD or DVD. Use of this type of media makes it more difficult for a malicious actor to alter the audit information.

In one embodiment, the auditing module 412 and/or audit information database 418 are maintained on a separate audit server. The audit server interacts with one or more messaging servers 112 and/or messaging clients 116 to store and track the audit information for the messaging system (or for multiple messaging systems). In one particular embodiment, the auditing module 412 resides in the messaging server 112 and generates tamper-detection data, but the audit information database 418 is located in a separate audit server and stores the tamper-detection data. Thus, the auditing module 412 generates the tamper-detection data and sends it to the audit information database 418 in an audit server for long term storage. In addition, the auditing module 412 interacts with the audit server to retrieve tamper-detection data when necessary or desired. In this embodiment, multiple messaging servers 112 can share a single audit information database 418 in the audit server.

In another embodiment, the operations performed by the auditing module 412 can be distributed across multiple modules and/or servers. For example, the auditing module 412 in the messaging server 112 can identify message components that require authentication, and send those message components to an audit server. The audit server uses information stored in the audit information database 418 to authenticate the message component and reports the result of the authentication back to the messaging server 112. In yet another embodiment, the messaging client 116, rather than the messaging server 112, performs the interactions with audit server. Those of skill in the art will appreciate that many other variations of these interactions are possible in different embodiments.

In one embodiment, some or all of the information in the message store database 120 is secured to prohibit unauthorized access. The security module 414 manages access to secured messages, submessages, and/or attachments and allows end-users to view only messages for which they are authorized. As part of this role, the security module 414 generates security information and stores it in the security database 420.

In one embodiment, the security database 420 stores keys utilized to encrypt message components provided to the proxy servers 114 and/or messaging clients 116. In one embodiment, each secured message component is encrypted with a different synchronous key using the Advanced Encryption Standard (AES). The typical key length varies from 128 bits to 4096 bits, depending upon the enterprise's security policy. The key is associated with the secured component, as opposed to being associated with an end-user and/or messaging client 116. Thus, the security module 414 can grant a messaging client 116 access to a secured component by providing the client with the component's key. Other embodiments use different types of security schemes, keys and/or key lengths to encrypt and decrypt message components.

In one embodiment, the security module 414 is adapted to digitally sign message components such as messages, submessages, attachments, and audit data. An entity that receives a signed message component, such as a messaging client 116, can use the digital signature to verify that the signed data has not been altered. A messaging client 116 that receives digitally-signed tamper-detection data from the messaging server 112 can use the signature to verify that the tamper-detection data itself has not been altered, and can use the tamper-detection data to verify that submessages etc. have not been altered. Thus, the digitally-signed tamper-detection data allows authentication in a distributed system.

In one embodiment, the security module 414 is adapted to monitor requests received by the messaging server 112 for audit, security, and/or other information and selectively control the information provided by the server. For example, in some circumstances it might be desirable to provide tamper-detection data to messaging servers 112, messaging clients 116, and other entities within the local messaging system, but to withhold such data from outside requesters. In other circumstances, it might be desirable to provide external messaging servers 112 with tamper-detection data related to only the message components sent to the servers. For example, if a messaging server 112 sends a submessage to an external messaging server, the security module 414 can allow the receiving messaging server to request tamper-detection data for that submessage. This embodiment can be instantiated by utilizing relatively long identifiers for the message components so that an external entity would be unlikely to forge a valid request. In another embodiment, the security module 414 provides tamper-detection data to any entity that requests it.

The governance module 422 controls the governance policy database 424. This database 424 stores governance policies for use by the messaging clients 116 and/or other entities in the messaging system. A governance policy includes one or more governance rules that describe the behaviors, rights, and/or privileges of the messaging client 116 and/or other entity for which the policy is applicable. For example, the governance policy can describe whether the messaging client 116 can cache message components. Likewise, the governance policy can specify whether an end-user can view cached content while the messaging client 116 is offline.

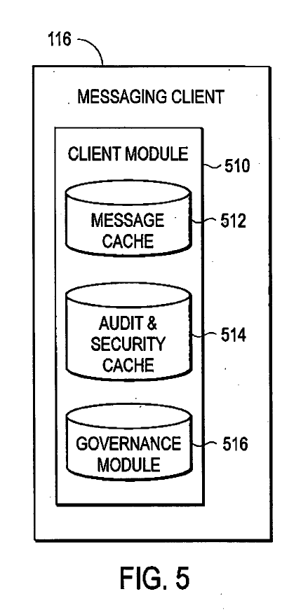

FIG. 5 is a high-level block diagram illustrating modules within the messaging client 116 according to one embodiment of the messaging system. The messaging client 116 includes a client module 510 adapted to utilize the messaging system. In one embodiment, the client module 510 is an application dedicated to sending and receiving messages via the messaging system. As such, it includes standard functionality for composing messages, viewing messages, replying to and forwarding messages, etc. In one embodiment, the client module 510 provides a graphical user interface (GUI) to the end-user that displays message components and related information. The GUI can include an element, such as a checkbox, that indicates whether a message component is authenticated. In another embodiment, the client module 510 operates in tandem with another module, such as a web browser or email application to provide integrated messaging functionality.

In one embodiment, the client module 510 includes a message cache 512 for caching submessages received by the client module. The client module 510 also includes an audit and security cache 514 for caching audit and/or security information received by the client module. The client module 510 utilizes the audit information, including the digitally-signed tamper-detection data, to verify the authenticity of submessages within the message cache 512. The client module 510 utilizes the security information in the audit and security cache 514 to access secured submessages stored in the message cache 512. In one embodiment, the client module 510 includes a governance module 516 for storing one or more governance policies received from the messaging server 112. The governance module 516 applies the governance policies to the messaging client 116. In one embodiment, the client module's actions with respect to auditing, securing, and applying governance policies are transparent to the end-user (i.e., occur automatically without any effort on the part of the end-user).

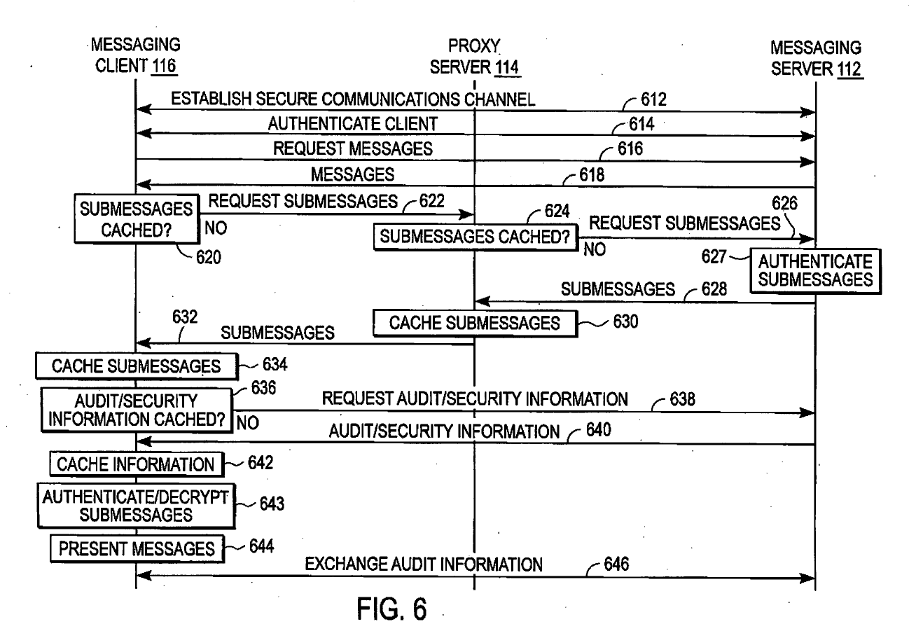

FIG. 6 is a flow diagram illustrating transactions between a messaging client 116, a proxy server 114, and a messaging server 112 according to one embodiment. FIG. 6 illustrates a specific set of transactions that occur when an end-user of a client 116 is accessing and reading messages. A person of skill in the art will recognize that embodiments of the messaging system can perform the illustrated transactions in orders different than the one shown in FIG. 6. Moreover, other embodiments can include different transactions instead of, or in addition to, the ones described here. For example, in one embodiment the proxy server 114 is absent and the messaging client 116 and messaging server 112 communicate directly. In another embodiment an audit server is present and there are additional transactions for communicating with the audit server.

Assume for purposes of this discussion that the messaging server 112 was in use prior to the transactions illustrated in FIG. 6. As part of this use, the messaging server 112 has stored multiple messages, including some messages created by and sent to the end-user of the messaging client 116. In addition, the messaging server 112 stores security and audit information for the messages.

The messaging client 116 and the messaging server 112 establish 612 a secure communications channel over the network 110. In one embodiment, the channel is opened using SSL or another protocol that allows the client 116 and server 112 to engage in encrypted communications. The messaging client 116 and messaging server 112 exchange 614 authentication information over the secure channel in order to authenticate the end-user of the messaging client.

Once the end-user is authenticated, the messaging client 116 requests 616 the end-user's messages from the messaging server 112. In response, the messaging server 112 sends 618 one or more message containers to the client 116. The messages do not include any content. Rather, the messages include references to submessages, references to any attachments, and/or references to other information about the messages.

Upon receiving the message containers from the messaging server 112, the messaging client 116 retrieves the submessages referenced therein. In one embodiment, the messaging client 116 queries 620 its local submessage cache 512 for the submessages. If some or all of the submessages are not cached locally, the messaging client 116 requests 622 the submessages from the proxy server 114. The proxy server 114 determines 624 whether the submessages are in its cache 118.

If the submessages are not cached, the proxy server 114 requests 626 the submessages from the messaging server 112. In one embodiment, the messaging server 112 uses the tamper-detection data to authenticate 627 each submessage before delivering it to the proxy server 114. To perform the authentication, the messaging server 112 recalculates the tamper-detection data (e.g., re-computes the hash) of the submessage and verifies that the data matches the previously calculated data. In one embodiment, any discrepancy between the original tamper-detection data and the data generated from the current content is reported to an administrator. The exact reporting technique can vary depending upon the policy of the enterprise operating the messaging server 112, the sensitivity of the data, the administrator's preferences, etc.

If the submessages authenticate, the messaging server 112 sends 628 the submessages to the proxy server 114. The proxy server 114 caches 630 the submessages. If the submessages were already cached at the proxy server 114, or after the submessages are retrieved from the messaging server 112, the proxy server sends 632 the cached submessages to the messaging client 116. The messaging client 116 may cache 634 the submessages upon receipt.

In one embodiment, the messaging client 116 may desire or find it necessary to authenticate and/or decrypt the submessages. The messaging client 116 determines 636 whether the audit information, such as the digitally-signed tamper-detection data, is stored in its local cache 514. Likewise, the messaging client 116 determines 636 whether the security information is stored in the cache 514. If the information is not cached, the messaging client 116 requests 638 and receives 640 the audit and/or security information from the messaging server 112 (or from the audit server, depending upon the embodiment).

The messaging client 116 uses the security information to decrypt the submessages. In addition, the messaging client 116 uses the audit information to determine whether the submessages have been tampered with and to thereby authenticate the submessages. To perform this latter step, one embodiment of the messaging client 116 verifies the signatures of the tamper-detection data in order to ensure that the data have not been altered. The messaging client 116 computes new tamper-detection data for the submessages to be authenticated, and then compares the new data with the data received from the messaging server 112. The authentication might fail, for example, if one of the end-users that acted on the message utilized a conventional (e.g., SMTP) messaging client that allowed the end-user to alter one of the history submessages. Such an alteration might occur innocently, such as when the messaging client appends chevrons to indicate text being replied-to, or maliciously, such as when the end-user intentionally alters text in a submessage to change its meaning. If the tamper-detection data match, the submessages have not been altered. If the data do not match, one embodiment of the messaging client 116 reports this result to the end-user and/or messaging server 112.

Then, the messaging client 116 presents 644 the messages to the end-user. The messaging client 116 may at this point exchange 646 audit information with the messaging server 612 to reflect actions performed at the client. As described above, the audit information exchange 646 can also occur at other points in the flow shown in FIG. 6. In one embodiment, audit information changes frequently during the operation of the messaging system and there are regular audit information exchanges between the messaging client 616 and the messaging server 612.

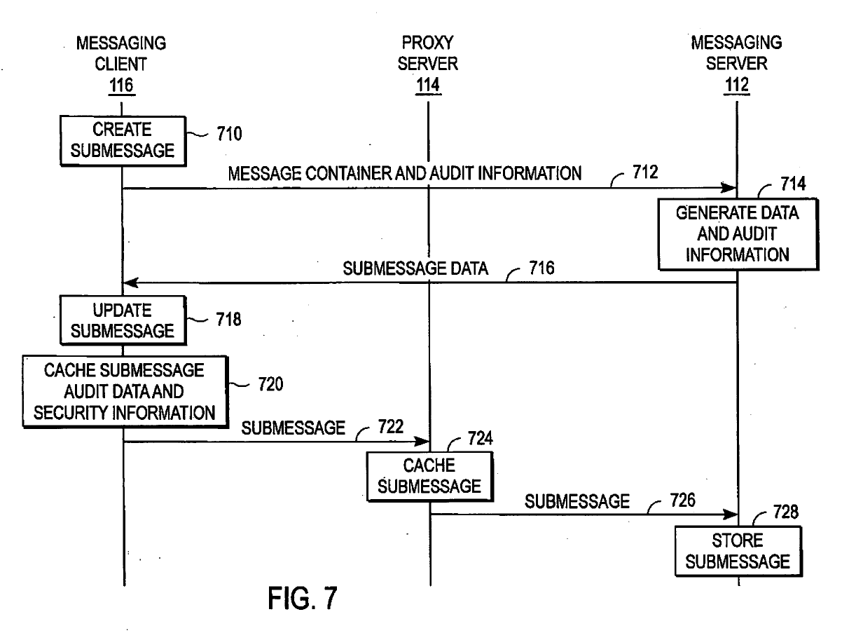

FIG. 7 is a flow diagram illustrating transactions between a messaging client 116, a proxy server 114, and a messaging server 112 according to one embodiment. FIG. 7 illustrates a specific set of transactions that occur when an end-user of a client 116 creates and sends a submessage. A person of skill in the art will recognize that embodiments of the messaging system can perform the illustrated transactions in orders different than the one shown in FIG. 7. Moreover, other embodiments can include different transactions instead of, or in addition to, the ones described here.

The end-user uses the messaging client 116 to create 710 a new submessage. In one embodiment, the end-user creates 710 a new submessage and message by pressing a “new” button on a GUI or performing another equivalent action. Similarly, the end-user can create a new submessage by replying to or forwarding an existing message. The end-user provides content for the submessage and associates zero or more attachments with it. As part of the messaging process, the end-user also specifies audit information associated with the submessage and/or message. The audit information can include, for example, the creator and the recipients of the submessage.

In one embodiment, the messaging client 116 contacts the messaging server 112 and provides 712 it with the message container and associated audit information indicating that a new submessage has been created. The messaging server 112 generates 714 an ID for the submessage and, if necessary, for the message. In addition, the messaging server 112 generates audit data.

The messaging server 112 stores the submessage and the audit information in the message 416 and audit information 418 databases, respectively. The messaging server 112 also generates the security information for the submessage and stores it in the security database 420. The messaging server 112 provides 716 the ID, security information and/or the audit information to the messaging client 116.

The messaging client 116 assigns 718 the ID received from the messaging server 112 to the submessage. The messaging client 116 secures 718 the submessage using the security information received from the messaging server 112 and stores 720 the secured submessage, audit information, and/or security information in its message 512 and audit/security 514 caches, respectively.

In one embodiment, the messaging client 116 also provides 722 the secured submessage to the proxy server 114. The proxy server 114 caches 724 the submessage and provides 726 a copy of it to the messaging server 112. The messaging server 112 stores 728 the submessage in its message database 416. In addition, the messaging server 112 generates tamper-detection data for the submessage, and stores this data in the audit information database 418.

The transactions described in FIGS. 6 and 7 can be expanded to provide distributed tamper-proof electronic messaging in environments having multiple messaging servers 112. Consider, for example, a scenario involving three messaging servers 112, three messaging clients 116, and three end-users, each respectively designated by the letters “A,” “B,” and “C.” Assume that end-user A on server A sends a message containing submessage A to an end-user B on server B. Also assume for purposes of this example that audit information is managed by a discrete audit server.

End-user A initially sends the message containing submessage A to server A. Server A computes the tamper-detection data for the submessage and sends it to the audit server for storage in the audit information database 418. In addition, server A sends the message and submessage to server B. Server B desires to authenticate submessage A, and therefore requests and obtains signed tamper-detection data for the submessage from the audit server. Server B recomputes the tamper-detection data for submessage A, and compares it to the signed data received from the audit information database 418. If the tamper-detection data match, then submessage A has not been altered. Therefore, Server B provides submessage A to end-user B and end-user B can be sure that it is authentic.

Now, end-user B composes a new submessage B and sends it to end-user C. Messaging server B receives submessage B from end-user B, computes tamper-detection data for it, and sends the data to the audit server. Messaging server B then sends the message and submessage B to messaging server C (messaging server C retrieves submessage A from messaging server A). Messaging server C desires to authenticate the two submessages in the message and therefore obtains the tamper-detection data for the submessages from the audit server. Messaging server C recomputes the tamper-detection data for each submessages and compares the data with the data from the audit server. Provided that the tamper-detection data match, the submessages are authentic and messaging server C presents the message containing submessages A and B to end-user C.

Many embodiments containing variations of the scenario described above are possible. For example, the messaging servers 112 can be within a single enterprise and communicate via a local area network. Alternatively, one or more of the messaging servers 112 can be located at different enterprises and communicate with other messaging servers via the Internet. Further, the messaging servers 112 can communicate by sending messages through one or more intermediate servers, such as conventional SMTP mail servers. In such an embodiment, the sending messaging server 112 can encode the message components in a conventional SMTP “envelope” that the receiving messaging server converts back into the messaging system representation. In another variation, there are multiple audit servers and, therefore, a messaging server 112 may need to retrieve tamper-detection data from multiple audit servers to authenticate a message.

In a further variation, the messaging client 116 contacts the messaging servers and/or audit server to authenticate message components. For example, messaging client C, which is used by end-user C, can receive an unauthenticated message containing submessages A and B. Messaging client C interacts with messaging servers A and B and/or the audit server to authenticate the submessages. This authentication can occur by having the servers send the tamper-detection data to messaging client C, or by having messaging client C send the submessages (or tamper-detection data generated from the submessages) to the servers and receive responses indicating whether the submessages are authentic.

In summary, the messaging system utilizes message components that can be independently stored, encrypted, and authenticated. In one embodiment, the messaging server 112 generates tamper-detection data, such as a hash, for each submessage. The messaging server 112 uses this tamper-detection data to authenticate submessages. In addition, the messaging server 112 digitally signs the tamper-detection data and provides it to messaging clients 116 to allow the clients to similarly authenticate the submessages.

The above description is included to illustrate the operation of the preferred embodiments and is not meant to limit the scope of the invention. The scope of the invention is to be limited only by the following claims. From the above discussion, many variations will be apparent to one skilled in the relevant art that would yet be encompassed by the spirit and scope of the invention.

We claim:

1. A computerized messaging server in an electronic messaging system, comprising:
a messaging module adapted to control a message database storing messages exchanged in the messaging system, each message comprising one or more message components;
an interface module adapted to receive a message component from a messaging client; and
an audit module adapted to interact with an audit information database storing audit information describing usage of the messaging system, and further adapted to generate tamper-detection data for the message component received from the messaging client and store the generated tamper-detection data in the audit information database.

2. The messaging server of claim 1, wherein the tamper-detection data comprises a hash computed responsive to one or more items of data selected from the group consisting of: a date that the message component was created; an author of the message component; a set of recipients of the message component; and content of the message component.

3. The messaging server of claim 1, wherein the interface module is further adapted receive a request from the messaging client for the message component in the message database and wherein the audit module is further adapted to utilize the tamper-detection data to authenticate the message component responsive to receiving the request for the message component from the messaging client.

4. The messaging server of claim 3, wherein the audit module is adapted to authenticate the message component by generating new tamper-detection data for the message component and comparing the new tamper-detection data with previously-generated tamper-detection data.

5. The messaging server of claim 3, wherein the interface module is further adapted to provide the tamper-detection data to the messaging client, and wherein the messaging client is adapted to utilize the tamper-detection data to authenticate the message component.

6. The messaging server of claim 5, wherein the tamper-detection data provided to the messaging client are signed with a digital signature and wherein the messaging client is adapted to utilize the digital signature to authenticate the tamper-detection data.

7. The messaging server of claim 1, wherein a message in the message database comprises:
a message container containing relational references to one or more message components.

8. The messaging server of claim 1, wherein a message in the message database comprises:
a current submessage specifying a most recent submessage in the message; and
a history submessage specifying a previous current submessage.

9. A computer program product having a computer-readable medium having embodied thereon program code for use in an electronic messaging system, the program code comprising:
a messaging module adapted to control a message database storing messages exchanged in the messaging system, each message comprising one or more message components;
an interface module adapted to receive a message component from a messaging client; and
an audit module adapted to interact with an audit information database storing audit information describing usage of the messaging system, and further adapted to generate tamper-detection data for the message component received from the messaging client and store the generated tamper-detection data in the audit information database.

10. The computer program product of claim 9, wherein the tamper-detection data comprises a hash computed responsive to one or more items of data selected from the group consisting of: a date that the message component was created; an author of the message component; a set of recipients of the message component; and content of the message component.

11. The computer program product of claim 9, wherein the interface module is further adapted receive a request from the messaging client for the message component in the message database and wherein the audit module is further adapted to utilize the tamper-detection data to authenticate the message component responsive to receiving the request for the message component from the messaging client.

12. The computer program product of claim 11, wherein the audit module is adapted to authenticate the message component by generating new tamper-detection data for the message component and comparing the new tamper-detection data with previously-generated tamper-detection data.

13. The computer program product of claim 11, wherein the interface module is further adapted to provide the tamper-detection data to the messaging client, and wherein the messaging client is adapted to utilize the tamper-detection data to authenticate the message component.

14. The computer program product of claim 13, wherein the tamper-detection data provided to the messaging client are signed with a digital signature and wherein the messaging client is adapted to utilize the digital signature to authenticate the tamper-detection data.

15. The computer program product of claim 9, wherein a message in the message database comprises:
a message container containing relational references to one or more message components.

16. The computer program product of claim 9, wherein a message in the message database comprises:
a current submessage specifying a most recent submessage in the message; and
a history submessage specifying a previous current submessage.

17. A computer-implemented method of authenticating messages in an electronic messaging system, comprising:
receiving a message component identified as a relational reference in a message container;
receiving tamper-detection data for the message component; and
authenticating the message component using the tamper-detection data.

18. The method of claim 17, wherein authenticating the message component comprises:
generating new tamper-detection data for authenticating the message component;
comparing the new tamper-detection data with the received tamper-detection data; and
determining whether the message component is authentic responsive to the comparison.

19. The method of claim 17, further comprising:
generating new tamper-detection data by computing a hash responsive to one or more items of data selected from the group consisting of: a date that the message component was created; an author of the message component; a set of recipients of the message component; and content of the message component.

20. The method of claim 17, wherein the message container identifies a plurality of message components, and further comprising:
obtaining the plurality of message components through interactions with a plurality of messaging servers, wherein each of the plurality of messaging servers provides at least one message component.

21. The method of claim 17, further comprising:
providing the message component to an audit server;
wherein the tamper-detection data is received from the audit server in response to the provided message component.
